(19) United States
(12) Patent Application Publication
(10) Pub. No.: US 2008/0152829 A1
(43) Pub. Date: Jun. 26, 2008

(54) COATING COMPOSITIONS, COATINGS FORMED THEREFROM AND METHODS OF MAKING THE SAME

(76) Inventors: Roy E. Dean, Lower Burrell, PA (US); Peter Kamarchik, Saxonburg, PA (US); Irina G. Schwendeman, Wexford, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/613,544

(22) Filed: Dec. 20, 2006

(51) Int. Cl. C08F 2/48

(52) U.S. Cl. 427/494; 106/287.35; 427/508

(57) ABSTRACT

A coating composition, comprising a film-forming component, a radiation curable group, and a matting agent, wherein, when the composition is deposited and treated to form a cured coating, the cured coating is characterized as having a higher concentration of the matting agent in a top half of the coating relative to a bottom half of the coating. Methods of treating a liquid radiation curable coating composition on a substrate are also disclosed, comprising applying an IR treatment to the liquid radiation curable coating composition, and applying a radiation curable treatment to the liquid radiation curable coating composition. The coating composition can provide improved properties, such as improved gloss, haze, flexibility, and/or chip resistance, when incorporated into a coating, or allow the use of less matting agent when compared to conventional coating compositions.

### FIELD

The present disclosure is directed to coating compositions, methods of forming the same, and coatings formed therefrom that exhibit improved coating properties, such as gloss.

### BACKGROUND

Coating formulations and their application over various substrates find use in numerous industries, such as, for example, in industries employing coated wood substrates. In these industries, and in the furniture manufacturing industry in particular, considerable efforts have been expended to develop coating compositions that provide manufacturing advantages, improved coating properties, and/or improved surface appearance. In the furniture manufacturing industry, for example, numerous techniques have been advanced to achieve manufacturing efficiencies, such as reduced coating times and costs, and/or improved physical properties, such as improved gloss and wood grain appearance, while still providing protection to the underlying wood substrate. These efforts have included, for example, the development of various waterborne or solvent-based coating formulations to the substrate, or the deposition of coating compositions by various coating techniques.

For example, radiation-curable systems have increasingly been employed to coat wood substrates as an alternative to conventional solvent-based finishes and drying techniques because of certain manufacturing or environmental advantages obtained from their use. These advantages include, for example, lower energy usage and virtually no VOC emissions. In addition, radiation-curable systems allow for flexibility in coating applications. For example, radiation-curable systems, such as UV-curable systems, allow for thicker film builds, if desired, with little or no lacquer bubbling, or, in the alternative, thinner coating applications employing virtually 100% solids with faster and more efficient drying times.

In addition to manufacturing considerations, other important considerations when employing coating formulations and their related methods include the overall appearance of the finished product. It has been found that the low-solids containing content and low viscosity of conventional waterborne coatings allow for desirable open-pore finishes, even when applied to complex surface contours and configurations. In contrast, although UV curable systems provide certain manufacturing advantages over conventional processes, it has been found that it is difficult to obtain close-to-the-grain appearance on wood products, for example, with high solids content coatings. This artificial or “plastic” look is especially evident at higher film builds.

Accordingly, the need exists for radiation-curable coating systems having high solids content and improved curing techniques wherein the resultant coatings exhibit one or more improved physical properties, such as improved gloss, relative to existing coating systems when deposited over various substrates.

### SUMMARY

In one embodiment, the present disclosure provides a method of treating a liquid radiation curable coating composition on a substrate, comprising applying an IR treatment to the liquid radiation curable coating composition, and applying a radiation curable treatment to the liquid radiation curable coating composition.

In another embodiment, the present disclosure provides a coating composition, comprising a film-forming component, a radiation curable group, and a matting agent, wherein, when the composition is deposited and treated to form a cured coating, the cured coating is characterized as having a higher concentration of the matting agent in a top half of the coating relative to a bottom half of the coating.

In yet another embodiment, the present disclosure provides a liquid radiation curable coating composition, comprising, a matting agent present in an amount of 1 to 6 weight percent based on the weight of the coating composition, wherein, when the composition is deposited and treated to form a cured coating, the cured coating is characterized as having a maximum gloss level of 10 to 60 gloss units, based on a GLOSS TEST METHOD.

Also provided is a method of altering an orientation of a matting agent distributed substantially uniformly in a liquid radiation curable coating composition positioned on a substrate. The method comprises applying an IR treatment to the liquid radiation curable coating composition comprising the matting agent, and applying a radiation curable treatment to the liquid radiation curable coating composition following the IR treatment. When cured, a higher concentration of the matting agent by weight percent is oriented near a top half of the coating relative to a bottom half of the coating.

It should be understood that this invention is not limited to the embodiments disclosed in this Summary, and it is intended to cover modifications that are within the spirit and scope of the invention, as defined by the claims.

### BRIEF DESCRIPTION OF THE DRAWINGS

FIG. 1 is a perspective view that is a 3-dimensional illustration of a coating surface roughness formed by a process of the present disclosure;

FIG. 2 is a perspective view that is a 3-dimensional illustration of a coating surface roughness formed by a conventional process;

FIG. 3 is a graph illustrating 20 degree gloss of coating samples incorporating various matting agents therein and exposed to IR radiation; and

FIG. 4 is a graph illustrating 60 degree gloss of coating samples incorporating various matting agents therein and exposed to IR radiation.

### DETAILED DESCRIPTION

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mn”) or weight average molecular weight (“Mw”)), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used. The terms “one,” “a,” or “an” as used herein are intended to include “at least one” or “one or more,” unless otherwise indicated.

As used herein, the term “polymer” is meant to refer to oligomers and both homopolymers and copolymers.

Also for molecular weights, whether Mn or Mw, these quantities are determined by gel permeation chromatography using polystyrene as standards as is well known to those skilled in the art and such as is discussed in U.S. Pat. No. 4,739,019 at column 4, lines 2-45, which is incorporated herein by reference in its entirety.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used herein “based on total weight of the resin solids” of the composition means that the amount of the component added during the formation of the composition is based upon the total weight of the resin solids (non-volatiles) of the film forming materials present during the formation of the composition, but not including any water, solvent, or any additive solids such as hindered amine stabilizers, photoinitiators, pigments including extender pigments and fillers, flow modifiers, catalysts, and UV light absorbers.

As used herein, “formed from” denotes open, e.g., “comprising,” claim language. As such, it is intended that a composition “formed from” a list of recited components be a composition comprising at least these recited components, and can further comprise other nonrecited components during the composition's formation.

As used herein, the term “cure” as used in connection with a composition, e.g., “a cured composition” or “radiation curable treatment” shall mean that any crosslinkable components of the composition are at least partially crosslinked. In certain embodiments of the present disclosure, the crosslink density of the crosslinkable components, i.e., the degree of crosslinking, ranges from 5% to 100% of complete crosslinking. In other embodiments, the crosslink density ranges from 35% to 85% of full crosslinking. In other embodiments, the crosslink density ranges from 50% to 85% of full crosslinking. One skilled in the art will understand that the presence and degree of crosslinking, i.e., the crosslink density, can be determined by a variety of methods, such as dynamic mechanical thermal analysis (DMTA) using a TA Instruments DMA 2980 DMTA analyzer conducted under nitrogen. This method determines the glass transition temperature and crosslink density of free films of coatings or polymers. These physical properties of a cured material are related to the structure of the crosslinked network.

The average particle size can be measured according to known laser scattering techniques. For example, the average particle size of such particles is measured using a Horiba Model LA 900 laser diffraction particle size instrument, which uses a helium-neon laser with a wave length of 633 nm to measure the size of the particles and assumes the particle has a spherical shape, i.e., the “particle size” refers to the smallest sphere that will completely enclose the particle.

As used herein, “thin film” refers to a film having a dry film thickness of less than 200 microns, typically less than 100 microns, usually within the range of 10 to 50 microns, and more usually within the range of 12 to 25 microns. As used herein, the phrase “film-forming material” refers to a material that by itself or in combination with a coreactive material, such as a crosslinking agent, is capable of forming a continuous film on a surface of a substrate.

The term “liquid” refers to any fluid free flowing material that has no independent shape but has a definite volume, does not expand indefinitely, and is only slightly compressible. The term “liquid” is meant to include slurry compositions.

Embodiments of the present disclosure provide coating compositions, coatings prepared therefrom, and methods of making the same. The coating composition may comprise a film-forming component, a radiation curable group, and a matting agent, wherein, when the composition is deposited and treated to form a cured coating, the cured coating is characterized as having a concentrated matting agent morphology. As used herein, “concentrated matting agent morphology” refers to a substantially non-uniform distribution of matting agent across a cross-section of a coating composition following curing, relative to conventional cured coating compositions that have substantially uniformly distributed matting agent within a thin film, and in some embodiments refers to a cured coating having a higher concentration of the matting agent in a top half of the coating relative to a bottom half of the coating. When the composition is applied and treated to form a cured coating, the cured coating is characterized as having a maximum gloss level of 10 to 60 gloss units, based on the GLOSS TEST METHOD, as described herein. Embodiments of the present disclosure also provide methods of treating a liquid radiation curable coating composition on a substrate, comprising applying an IR treatment to the liquid radiation curable coating composition, and applying a radiation curable treatment to the liquid radiation curable coating composition.

The liquid radiation-curable composition may be deposited on any suitable substrate in any manner known to those of ordinary skill in the art. As used herein, the phrase “deposited on” or “deposited over” a substrate, and like terms, means deposited or provided above or over but not necessarily adjacent to the surface of the substrate. For example, a coating can be deposited directly on the substrate or one or more other coatings can be applied therebetween. In certain embodiments, the coating compositions may be sprayable over the substrate. As used herein, the term “sprayable” refers to compositions that are capable of being applied uniformly by atomization through a device such as a spray gun. Sprayability, as will be appreciated by those skilled in the art, is a function of the viscosity of a material. In certain embodiments, the compositions of the present disclosure have a viscosity of from 2 to 300 centipoise or, in other embodiments, from 20 to 150 centipoise, or, in yet other embodiments, 20 to 120 centipoise, at high shear at 25° C. (77° F.). The viscosities reported herein may be determined using a Cone and Plate viscometer at 5000 cycles per second as understood by those skilled in the art. Suitable substrates include, for example, a material such as, for example, a metal, a glass, a polymeric material, a wood material, such as a wood fiber-containing material, a wood composite, a wood laminate, a wood veneer, an imitation wood grain material, and combinations of at least two thereof. In this regard, when used herein, materials such as a “metal,” a “glass,” a “wood,” and a “polymeric,” material are meant to include the various composite materials formed from these materials, in addition to those materials that have a substantially solid or pure composition. Other suitable substrates include, for example, any of the various other possible manmade or naturally formed materials that may find a benefit from employing the coating compositions or methods set forth herein, such as, for example, concrete, stone, brick, tile, composites thereof, and their combinations.

Any suitable liquid radiation-curable coating composition may be deposited over the various substrates of the present disclosure, and, in some embodiments, may comprise a film-forming component, a radiation-curable group, and a matting agent. Suitable commercially available compositions modified by embodiments of the present disclosure include, for example, R1742Z49, a commercially available sealer composition, and R1707Z83, a commercially available topcoat composition, both available from PPG, Industries, Pittsburgh, Pa. The coating composition provided herein may be, for example, a UV curable thermosetting composition or a thermoplastic composition. In embodiments of the present disclosure, the coating composition may comprise a thermosetting composition comprising a film-forming component comprising a functional group-containing resinous binder and, optionally, a crosslinking agent that are reactive with the functional groups of the film-forming component. The thermosetting coating composition may include a crosslinking agent or may be capable of self-crosslinking, i.e., it contains reactive groups that are capable of reacting with each other to form a crosslinked network.

In certain embodiments, the components that comprise the film-forming material, when cured, form a thin film having a concentrated matting agent morphology that is “locked” in place when the thermosetting composition is cured. Generally, the components that form the radiation-curable film-forming material will be present in the thermosetting composition at a level that will result in the formation of a concentrated matting agent morphology.

For example, in certain embodiments of the present disclosure the radiation curable compositions may be an acrylate-based composition and may comprise, for example, a mixture of (a) an acrylated epoxy, (b) a radiation curable group, such as at least one multi-functional acrylate and, in certain embodiments, (c) a photoinitiator, and (d) a matting agent. The radiation curable compositions of the present disclosure may comprise a material containing an amino group. In certain embodiments of the present disclosure, the compositions may be substantially free of inert solvents and/or monofunctional reactive diluents, such as monofunctional acrylate monomers.

As will be appreciated by those skilled in the art, epoxy acrylates may be produced through reaction of epoxy resins with (meth)acrylic acids. As used herein, “(meth)acrylic” and terms derived therefrom are intended to include both acrylic and methacrylic. Moreover, in certain embodiments of the present disclosure, the acrylated epoxy comprises an oligomer having a viscosity at 25° C. (77° F.) of less than 10,000 centipoise, or, in some cases, less than 5,000 centipoise, or, in other cases, about 1,000 centipoise. In certain embodiments of the present disclosure, the acrylated epoxy comprises an oligomer having a Tg (glass transition temperature) of less than 50° C. (122° F.), or, in some cases, less than 25° C. (77° F.) or, in still other cases, less than 0° C. (32° F.), or, in yet other cases, less than −10° C. (14° F.).

Suitable acrylated epoxies that may be used in the compositions of the present disclosure include, without limitation, those which are the reaction product of compounds having at least one epoxide group with compounds having per molecule at least one α,β-ethylenically unsaturated double bond and at least one group which is reactive toward epoxide groups. In certain embodiments, the acrylated epoxy may comprise a multi-functional acrylated epoxy. As used herein, the term “multi-functional acrylated epoxy” refers to acrylated epoxies having an acrylate functionality of greater than 1.0.

Some specific examples of commercially available acrylated epoxies that are suitable for use in the compositions of the present disclosure include, without limitation, EBECRYL 3200, 3201, 3211 and 3212, available from UCB Chemicals Corporation, Smyrna, Ga.; PHOTOMER 4025, available from Cognis Corp., Cincinnati, Ohio; LAROMER 8765, available from BASF Corp., Charlotte, N.C.; and CN115, available from Sartomer Corp., Exton, Pa.

In certain embodiments of the present disclosure, the composition may comprise at least 10 percent by weight of acrylated epoxy or, in some embodiments, at least 15 percent by weight of acrylated epoxy or, in yet other cases, 20 percent by weight up to 80 percent by weight, or, in still other embodiments, from 35 up to 65 percent by weight of acrylated epoxy based on the total weight of the radiation curable composition. In certain embodiments, the composition may comprise 10 up to 30 percent by weight of acrylated epoxy based on the total weight of the radiation curable composition. The amount of acrylated epoxy present in the radiation curable compositions can range between any combination of these values inclusive of the recited values.

The coating composition of the present disclosure may also comprise a radiation curable agent or group. For example, useful radiation-curable groups which can be present as reactive functional groups on the polysiloxane include unsaturated groups such as vinyl groups, acrylate groups, methacrylate groups, ethacrylate groups, epoxy groups such as cycloaliphatic epoxy groups. In one embodiment, the radiation curable group may be UV curable and can include acrylate groups, maleimides, fumarates, and vinyl ethers. Compositions such as those provided in U.S. Pat. No. 7,053,149, incorporated by reference herein in its entirety, provide suitable radiation curable coating compositions for use in the present disclosure.

Suitable radiation curable groups include, for example, at least one multi-functional acrylate. As used herein, the term “multi-functional acrylate” refers to monomers or oligomers having an acrylate functionality of greater than 1.0, such as at least 2.0. Multifunctional acrylates suitable for use in the compositions of the present disclosure include, for example, those that have a relative molar mass of from 170 to 5000 grams per mole, such as 170 to 1500 grams per mole. In the compositions of the present disclosure, the multi-functional acrylate may act as a reactive diluent that is radiation curable. Upon exposure to radiation, a radical induced polymerization of the multi-functional acrylate with monomer or oligomer is induced, thereby incorporating the reactive diluent into the coating matrix.

Multi-functional acrylates suitable for use in the radiation curable compositions of the present disclosure may include, without limitation, difunctional, trifunctional, tetrafunctional, pentafunctional, hexafunctional (meth)acrylates and mixtures thereof. As used herein, “(meth)acrylate” and terms derived therefrom are intended to include both acrylates and methacrylates.

Representative examples of suitable multi-functional acrylates include, without limitation, ethylene glycol di(meth)acrylate, 1,3-butylene glycol di(meth)acrylate, 1,4-butanediol diacrylate, 2,3-dimethylpropane 1,3-diacrylate, 1,6-hexanediol di(meth)acrylate, dipropylene glycol diacrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, tripropylene glycol di(meth)acrylate, thiodiethylene glycol diacrylate, trimethylene glycol dimethacrylate, pentaerythritol tri(meth)acrylate, trimethylolpropane tri(meth)acrylate, ditrimethylolpropane tetra(meth)acrylate, glycerolpropoxy tri(meth)acrylate, ethoxylated trimethylolpropane tri(meth)acrylate, and tetraethylene glycol di(meth)acrylate, including mixtures thereof.

In certain embodiments, the radiation curable compositions of the present disclosure may comprise less than 90 percent by weight of multifunctional acrylate or, in some embodiments, less than 85 percent by weight or, in yet other embodiments, more than 20 percent by weight up to less than 80 percent by weight, or, in still other embodiments, from 35 up to 65 percent by weight of multifunctional acrylate based on the total weight of the radiation curable composition. The amount of multifunctional acrylate present in the radiation curable compositions can range between any combination of these values inclusive of the recited values.

In certain embodiments, particularly when the radiation curable composition is to be cured by UV radiation, the compositions of the present disclosure also comprise a photoinitiator. As will be appreciated by those skilled in the art, a photoinitiator absorbs radiation during cure and transforms it into chemical energy available for the polymerization. Photoinitiators are classified in two major groups based upon a mode of action, either or both of which may be used in the compositions of the present disclosure. Cleavage-type photoinitiators include acetophenones, α-aminoalkylphenones, benzoin ethers, benzoyl oximes, acylphosphine oxides and bisacylphosphine oxides and mixtures thereof. Abstraction-type photoinitiators include benzophenone, Michler's ketone, thioxanthone, anthraquinone, camphorquinone, fluorone, ketocoumarin and mixtures thereof. Other examples of photoinitiators and photosensitizers can be found in U.S. Pat. No. 4,017,652, incorporated by reference herein in its entirety.

Specific nonlimiting examples of photoinitiators that may be used in the radiation curable compositions of the present disclosure include benzil, benzoin, benzoin methyl ether, benzoin isobutyl ether benzophenol, acetophenone, benzophenone, 4,4′-dichlorobenzophenone, 4,4′-bis(N,N′-dimethylamino)benzophenone, diethoxyacetophenone, fluorones, e.g., the H-Nu series of initiators available from Spectra Group Ltd., 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, e.g., 2,6-dimethylbenzoyldiphenyl phosphine oxide, 2,4,6-trimethylbenzoyldiphenylphosphine oxide, bis(2,4,6-trimethylbenzoyl) phenyl phosphine oxide, 2,6-dichlorobenzoyl-diphenylphosphine oxide, and 2,6-dimethoxybenzoyldiphenylphosphine oxide, bisacylphosphine oxides, e.g., bis(2,6-dimethyoxybenzoyl)-2,4,4-trimethylepentylphosphine oxide, bis(2,6-dimethylbenzoyl)-2,4,4-trimethylpentylphosphine oxide, bis(2,4,6-trimethylbenzoyl)-2,4,4-trimethylpentylphosphine oxide, and bis(2,6-dichlorobenzoyl)-2,4,4-trimethylpentylphosphine oxide, and mixtures thereof.

In certain embodiments, the radiation curable compositions of the present disclosure may comprise 0.01 up to 15 percent by weight of photoinitiator or, in some embodiments, 0.01 up to 10 percent by weight, or, in yet other embodiments, 0.01 up to 5 percent by weight of photoinitiator based on the total weight of the radiation curable composition. The amount of photoinitiator present in the radiation curable compositions can range between any combination of these values inclusive of the recited values.

The radiation curable compositions of the present disclosure may also comprise a material containing an amino group. In the compositions of the present disclosure, the amino group may be present as part of the acrylated epoxy, as part of the at least one multi-functional acrylate, or the amino group may be present in a separate component of the radiation curable composition.

In certain embodiments, the radiation curable compositions of the present disclosure may comprise an amine modified (meth)acrylate. Amine modified (meth)acrylates suitable for use in the present disclosure are known in the art and include, without limitation, amine modified polyether acrylates, amine modified polyester acrylates, amine modified epoxy acrylates, and amine modified urethane acrylates, including mixtures thereof.

Representative specific examples of commercially available amine modified (meth)acrylates suitable for use in the compositions of the present disclosure include, without limitation, the LAROMER line of amine-modified acrylates available from BASF Corporation, Charlotte, N.C., such as LAROMER PO77F, PO94F, and LR8996; CN501, CN50, CN550, and CN551 available from Sartomer Corp., Exton, Pa.; and ACTILANE 525, 584, and 587 available from Akcros Chemicals, New Brunswick, N.J.

In certain embodiments, the radiation curable compositions of the present disclosure may comprise at least 5 percent by weight, or, in some cases, at least 10 percent by weight, or, in yet other cases, at least 20 percent by weight of a material containing an amino group based on the total weight of the radiation curable composition. In some embodiments, the radiation curable composition may comprise 5 up to 50 percent by weight or, in other cases, 10 up to 30 percent by weight of a material containing an amino group based on the total weight of the radiation curable composition. The amount of the material containing an amino group present in the radiation curable compositions can range between any combination of these values inclusive of the recited values.

In certain embodiments, the compositions of the present disclosure are substantially free of monofunctional reactive diluents (such as monofunctional acrylate monomers) and/or inert solvents (such as water and inert organic solvents). As used herein, “substantially free” means that the material is present in the composition, if at all, as an incidental impurity. In other words, the material is not intentionally added to the composition, but may be present at minor or inconsequential levels, because it was carried over as an impurity as part of an intended composition component. In certain embodiments, for example, monofunctional reactive diluents and/or inert solvent are present in the compositions of the present disclosure in an amount of less than 10 percent by weight or, in some cases, less than 5 percent by weight, and, in yet other embodiments, less than 2 percent by weight based on total weight of the composition. In some embodiments, for example, the compositions of the present disclosure are free of monofunctional reactive diluents.

The coating composition of the present disclosure may also include a matting agent. Any matting agent known to those of ordinary skill in the art may be employed in embodiments of the present disclosure. For example, suitable matting agents include, for example, silica matting agents, mica, talc, Ca or Mg stearate, and other matting agents known to those of ordinary skill in the art having suitable surface treatment, pore size, and particle size. Commercially available matting agents include, for example, Gasil IJ37, HP220, and UV 70C, all commercially available from Ineos Silicas, Joliet, Ill., Syloid RAD 2005 and Syloid Rad 2105, both commercially available from Grace Davidson, Suffolk, Va. The amount of matting agent employed in embodiments of the present disclosure can vary based on, for example, the type of matting agent and the coating composition employed, but is generally present in the coating composition in an amount of 0.1 to 20 weight percent, in certain embodiments is present in an amount of 0.1 to 6 weight percent, and in other embodiments is present in an amount of 2.5 to 6 weight percent, based on the weight of the coating composition. The amount of matting agent present in the radiation curable compositions can range between any combination of these values inclusive of the recited values.

To achieve improved gloss properties on the coated substrate, the film forming component may be curable or thermosettable as provided hereinbelow. The film-forming material may be self-crosslinking, although external crosslinking agents can be used.

Other ingredients such as pigments and fillers can be present in the coating composition. Useful pigments include hiding pigments such as titanium dioxide, zinc oxide, antimony oxide, etc. and organic or inorganic UV opacifying pigments such as iron oxide, transparent red or yellow iron oxide, carbon black, phthalocyanine blue, and the like. When it is desired to cure the composition with ultraviolet light, the pigment utilized is typically an ultraviolet light transparent pigment. The phrase “ultraviolet light transparent” is used to mean that the pigment does not substantially interfere with UV curing of the composition. Examples of ultraviolet light transparent pigments include talc, calcium carbonate, aluminum silicate, magnesium silicate, barytes, and silica (SiO₂). Coloring pigments generally employed to impart color in non-UV cured coating compositions typically absorb or block ultraviolet light, thereby interfering with UV curing of the composition. Accordingly, where some degree of color tinting of the composition is desired, such conventional coloring pigments typically are employed in only limited amounts when cure is to be effected utilizing UV radiation. Useful fillers include barium sulfate, magnesium silicate, calcium carbonate, and silica. Fillers and pigments can be present in amounts of up to 60 parts by weight or less based on 100 parts by weight of total solids of the coating composition.

Other optional ingredients can include anti-oxidants, UV-absorbers and hindered amine light stabilizers, such as for example, hindered phenols, benzophenones, benzotriazoles, triazoles, triazines, benzoates, piperidinyl compounds and mixtures thereof. These ingredients are typically added in amounts up to 2 percent based on the total weight of resin solids of the composition. Other optional ingredients include water miscible materials, reactive diluents, co-solvents, coalescing aids, defoamers, plasticizers, associative thickeners, bactericides and the like. The radiation-curable composition of the present disclosure may also contain a solvent such as conventional aliphatic and aromatic solvents or diluents known in the art.

It is contemplated that depending upon the desired application and intended use, the coating compositions of the present disclosure may be incorporated into any liquid coating composition, including aqueous slurry coating compositions. As described hereinbelow, the percent solids of the coating composition and the thickness of the coating composition as applied to the substrate can vary based upon such factors as the particular type of coating that is formed from the coating composition of the present disclosure, i.e. whether the coating composition is used in a sealer/surfacer, as a basecoat, topcoat, or combinations thereof, or monocoat composition; and the type of substrate and intended end use of the substrate. In certain embodiments of the present disclosure, the coating composition is a liquid radiation, such as UV, curable composition having a solids content of at least 50% solids. In certain embodiments of the present disclosure, the coating composition is a radiation, such as UV curable, composition having a solids content that is substantially 100% solids.

In addition, it is contemplated that the coating composition of the present disclosure may be used to form a multilayer composite coating for application over a substrate including any of the previously mentioned substrates. For example, embodiments of the present disclosure contemplate that compositions set forth herein may be employed in at least one layer of a multilayer composite coating. For example embodiments of the present disclosure may include a multilayer composite coating that comprises a primer or sealer deposited from a sealer coating composition and a topcoat applied over at least a portion of the sealer, wherein at least one of the sealer composition and the topcoat composition comprise the coating composition of the present disclosure.

Generally, the methods contemplated herein include a method of treating a liquid radiation curable coating composition on a substrate, comprising applying an IR treatment to the liquid radiation curable coating composition, and applying a radiation curable treatment to the liquid radiation curable coating composition. In certain embodiments provided herein, and as set forth in the Examples, the radiation curable coating composition is a UV curable composition that is cured by means of a UV curable radiation treatment.

In embodiments provided herein, compositions of the present disclosure may be deposited on the surface of the substrate or over a previously formed polymeric underlayer by any suitable coating process known to those of ordinary skill in the art, for example, by dip coating, direct roll coating, reverse roll coating, curtain coating, spray coating, brush coating, electrostatic spray coating, and combinations of any thereof. The method and apparatus for applying the coating composition to the substrate is determined in part by the configuration and type of substrate material. In this regard, the coatings of the present disclosure may be deposited over the substrates set forth herein by these application methods. When applied over a plastic substrate, the compositions of the present disclosure are at least partially cured at a temperature below the thermal deformation temperature of the plastics.

By way of a non-limiting example, the coating compositions set forth herein may be deposited on the substrate as a monocoat, or employed in a sealer/topcoat multicoat composite and deposited on the substrate. In this latter example, the coating composition provided herein may be incorporated into one or both of the sealer and topcoat layers such that the sealer is deposited to at least partially coat the substrate and the topcoat is deposited to at least partially coat the sealer layer. As such, the present disclosure contemplates coating composites having at least two coating layers deposited from at least two coating compositions, in which at least one of the coating compositions may be the same or different from the other coating composition(s).

The following example illustrates an embodiment of the present disclosure comprising a sealer/topcoat deposition method and resultant coating, and is provided by way of illustration only. One of ordinary skill in the art will recognize that the coating composition may, but need not, be applied in this manner, and that other coatings may be formed and that other coating methods may be employed.

When employed, the sealer composition can be a waterborne coating composition or a solventborne coating composition. In an embodiment of the present disclosure, the sealer composition may comprise a waterborne composition. The sealer coating composition may contain the coating composition of the present disclosure or may be a conventional sealer composition such as, for example, R1742Z49, a commercially available sealer composition available from PPG, Industries, Pittsburgh, Pa. When the sealer composition contains the coating composition of the present disclosure, the percent solids of the coating composition in the sealer composition may range from 50 to 100% and in some embodiments may be substantially 100% solids by weight based on total weight of the resin solids of the sealer composition.

The sealer composition can be deposited on the surface of the substrate, and be adjacent thereto, by any suitable coating process known to those of ordinary skill in the art, for example, by dip coating, direct roll coating, reverse roll coating, curtain coating, spray coating, brush coating, electrostatic spray coating, and combinations thereof. The sealer coating can, but need not, be dried or cured before topcoating, as discussed below.

A sealer composition may be treated and cured, such as by conventional processes, by the techniques provided herein, or left as a substantially uncured sealer coating prior to the application of the topcoat layer. As used herein, “substantially uncured” coating means that the coating composition, after application to the surface of the substrate, forms a film or coating that is substantially uncrosslinked, i.e., is not heated to a temperature sufficient to induce significant crosslinking and there is substantially no chemical reaction between the thermosettable dispersion and the crosslinking material.

During application of the sealer coating composition to the substrate, ambient relative humidity generally can range from 30 to 90 percent, and in some embodiments can range from 60 percent to 80 percent.

After application of the sealer coating composition to the substrate, the sealer coating can be radiation cured, such as by UV radiation, or at least partially dried by conventional processes, such as by evaporating water and solvent (if present) from the surface of the film by various methods, treated and cured by the methods set forth herein, or by air drying at ambient (about 25° C.) or an elevated temperature for a period sufficient to dry the film. The treatment can be for a short period of time sufficient to ensure that a topcoat composition can be applied over the sealer coating essentially without dissolving the sealer coating. Suitable drying conditions will depend on the components of the sealer coating and on the ambient humidity, but in general a drying time of 30 minutes at a temperature of 60° C. will be adequate to ensure that mixing of the sealer coating and the topcoat composition is minimized. The drying temperature can range from 40° C., and typically ranges from 40 to 80° C. Also, multiple sealer coating compositions can be applied to develop the optimum appearance if desired. Between coats, and if desired, the previously applied coat may be sanded and/or “flashed”; that is, exposed to ambient conditions for 30 minutes.

Typically, the coating thickness of the sealer coating after final drying and curing of the multilayer composite coating ranges from 0.2 to 2.0 mils (5.1 to 50.8 micrometers), and can range from 0.4 to 1.0 mils (10.2 to 25.4 micrometers).

A topcoat composition may be deposited over at least a portion of a surface of the sealer coating, and in some embodiments may be applied in a wet-on-wet application without substantially drying or curing the sealer layer. The topcoat composition may contain the coating composition of the present disclosure or may be a conventional topcoat coating composition such as, for example, R1707Z83, a commercially available topcoat composition available from PPG, Industries, Pittsburgh, Pa. When the topcoat composition contains the coating composition of the present disclosure, the percent solids of the coating composition of the present disclosure may range from 50 to 100 percent, and may be substantially 100 percent by weight, based on total weight of the resin solids of the topcoat composition. In one embodiment, the topcoat composition contains a suitable matting agent, as set forth herein.

The topcoat composition can be a waterborne coating or solventborne coating. The topcoat may be a monocoat or a system incorporating multiple coating layers.

Following deposition of the one or more layers that comprise the coating composition set forth herein, the coating layer or layers may be conventionally dried and cured, in a manner similar to the sealer composition, above, or, in the alternative, may be at least partially treated by means of infrared radiation (“IR”) followed by a radiation cure application. Generally, there are three categories of IR. These categories are: near-IR (short wavelength) having a peak wavelength from 0.75 to 2.5 microns (“u”) (750 to 2500 nanometers); intermediate-IR (medium wavelength) having a peak wavelength from 2.5 to 4 u (2500 to 4000 nanometers); and far-IR (long wavelength) having a peak wavelength from 4 to 1000 u (4000 to 100,000 nanometers). Any combination or all of these categories of IR can be used to treat the coating. For example, in certain embodiments, the IR treatment may be applied to the coating composition at an intensity level in a range of 750 to 100,000 nanometers at a peak temperature range. In certain other embodiments, the IR treatment may be applied to the coating composition at an intensity level in the range of 5000 to 25000 nanometers at a peak temperature range.

The infrared radiation may be emitted by a plurality of emitters arranged in the interior treatment chamber. Each emitter may be a high intensity infrared lamp, such as a quartz envelope lamp having a tungsten filament. Useful short wavelength (0.76 to 2 micrometers), high intensity lamps include Model No. T-3 lamps such as are commercially available from General Electric Co., Sylvania, Phillips, Heraeus and Ushio and have an emission rate of between 75 and 100 watts per lineal inch at the light source. Medium wavelength (2 to 4 micrometers) lamps also can be used and are available from the same suppliers. Each medium wavelength emitter may be a medium intensity infrared lamp, such as a quartz envelope lamp having a carbon filter filament.

The number of emitters and their orientation may vary depending upon the desired intensity of energy to be emitted and the duration of the treatment. Depending upon such factors as the configuration and positioning of the substrate within the interior treatment chamber, the emitter lamps can be independently controlled by microprocessor such that the emitter lamps furthest from the surface of the substrate can be illuminated at a greater intensity than lamps closest to the surface of the substrate to provide uniform treatment.

In certain embodiments of the present disclosure, the IR treatment may be applied to the coating composition prior to the application of the radiation treatment, such as UV radiation, that cures the coating composition. In certain embodiments, the application of the IR treatment has been found to orient the matting agent within the substantially uncured liquid coating composition. As such, in embodiments of the present disclosure, the IR treatment is not applied for a time or at an intensity sufficient to cure the coating, but, instead, is meant to orient the matting agent within the liquid coating composition prior to cure. Accordingly, in certain embodiments, the IR treatment may be applied to the coating composition for a relatively short period of time, prior to, and in some embodiments, immediately prior to, the radiation cure. For example, in certain embodiments, the IR treatment may be applied to the coating composition for up to 60 seconds, and in some embodiments, for 1 to 10 seconds, and in other embodiments, for 5 to 10 seconds. In this manner, unlike conventional IR applications that are applied for a time and intensity that substantially immediately cures the coating composition, embodiments of the present disclosure apply an IR treatment that treats, but does not cure, the coating composition.

It has been found that in certain embodiments of the present disclosure, IR treatment, when applied to the coating composition as set forth herein, provides a coating over a substrate that can be characterized as having a concentrated matting agent morphology in the top half of the coating. In certain embodiments, it has been found that, at least partially due to the IR treatment, the matting agent, which is originally substantially uniformly distributed throughout the liquid coating composition when deposited on the substrate, orients itself toward the surface of the uncured coating composition. In certain embodiments, the coating can be characterized as having a higher concentration of the matting agent in a top half of the coating relative to a bottom half of the coating. In other embodiments, a substantial majority, by weight percent, of the matting agent is concentrated in the top half of the coating. For example, in embodiments of the present disclosure, the coating composition comprises a matting agent orientation wherein at least 70% by weight of the matting agent present in the coating composition is present in the top half of the cured coating. In other embodiments of the present disclosure, at least 70 to 100% by weight of the matting agent is present in the top half of the cured coating. When cured to form a thin film, described hereinbelow, coating compositions of embodiments of the present disclosure have their concentrated matting agent morphology “locked” in place. As provided in the Examples, the resultant coating can exhibit improved gloss and reduced haze relative to prior art coatings, as well as improved flexibility and chip resistance.

In this manner, embodiments of the present disclosure provide methods of altering an orientation of a matting agent distributed substantially uniformly in a liquid coating composition positioned on a substrate. The method comprises applying an IR treatment to the liquid coating composition comprising the matting agent, and applying a curable treatment to the liquid curable coating composition following the IR treatment, such that, when cured, a majority, and in some embodiments, a substantial majority, of the matting agent by weight percent is oriented in a top half of the coating.

The coating compositions of the present disclosure may be subject to various curing techniques known to those of ordinary skill in the art that are suitable to form a thin film having a concentrated matting agent morphology, wherein IR is employed to orient the matting agent that is “locked” in place when the coating composition is cured. Curing may also be performed in a selective manner, depending on substrate configuration, wherein more than one form of curing technique may be performed in different areas of the substrate. For example, in certain embodiments of the present disclosure, any suitable ionizing and/or actinic radiation curable techniques, such as UV radiation, may be employed to cure the coating composition of the present disclosure.

As used herein, “ionizing radiation” means high energy radiation and/or the secondary energies resulting from conversion of this electron or other particle energy to neutron or gamma radiation, said energies being at least 30,000 electron volts and can range from 50,000 to 300,000 electron volts. While various types of ionizing irradiation are suitable for this purpose, such as X-ray, gamma and beta rays, the radiation produced by accelerated high energy electrons or electron beam devices may be employed in certain embodiments. The amount of ionizing radiation in rads for curing compositions according to the present disclosure can vary based on factors such as the components of the coating formulation, the thickness of the coating upon the substrate, the temperature of the coating composition and the like. Generally, a 1 mil (25 micrometer) thick wet film of a coating composition according to the present disclosure can be cured in the presence of oxygen through its thickness to a tack-free state upon exposure to from 0.5 to 5 megarads of ionizing radiation.

“Actinic radiation” is light with wavelengths of electromagnetic radiation ranging from the ultraviolet (“UV”) light range, through the visible light range, and into the infrared range. Actinic radiation which can be used to cure coating compositions of the present disclosure generally has wavelengths of electromagnetic radiation ranging from 150 to 2,000 nanometers (nm), and can range from 250 to 1,500 nm. UV radiation generally has wavelengths of electromagnetic radiation ranging from 150 to 400 nm. Examples of suitable ultraviolet light sources include mercury arcs, carbon arcs, low, medium or high pressure mercury lamps, swirl-flow plasma arcs and ultraviolet light emitting diodes. Suitable ultraviolet light-emitting lamps are medium pressure mercury vapor lamps having outputs ranging from 200 to 600 watts per inch (79 to 237 watts per centimeter) across the length of the lamp tube. Generally, a 1 mil (25 micrometer) thick wet film of a coating composition according to the present disclosure can be cured through its thickness to a tack-free state upon exposure to actinic radiation by passing the film at a rate of 20 to 1000 feet per minute (6 to 300 meters per minute) under four medium pressure mercury vapor lamps of exposure at 200 to 1000 millijoules per square centimeter of the wet film. In certain embodiments of the present disclosure, the UV treatment substantially cures the liquid UV curable coating composition.

Typically, the coating thickness of the topcoat after final drying and curing of the multilayer composite coating ranges from 0.2 to 2.0 mils (5.1 to 50.8 micrometers), and can range from 0.4 to 1.0 mils (10.2 to 25.4 micrometers).

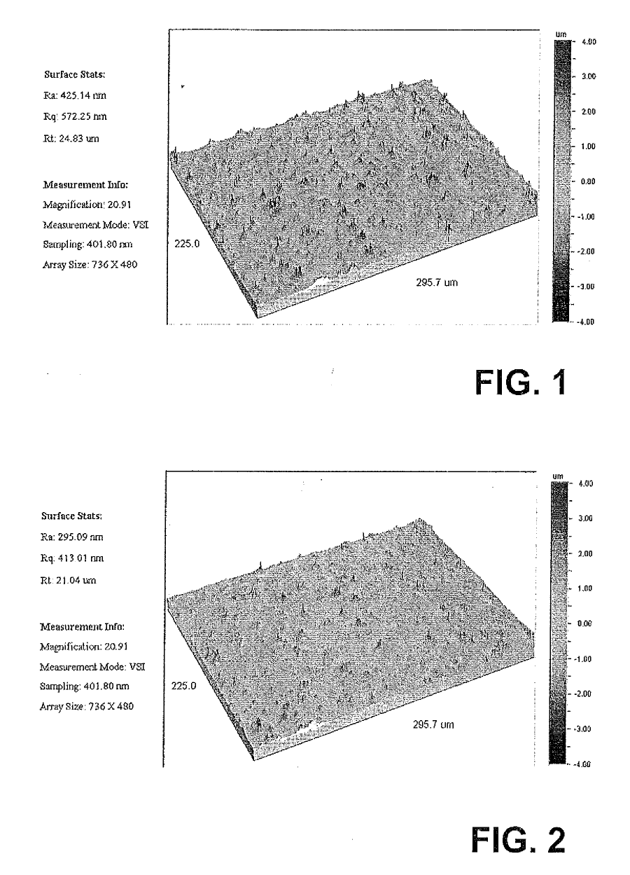

Following curing, the matting agent of the coating composition as set forth herein may be locked in place in its orientation such that the cured coating comprises a higher concentration of the matting agent in a top half of the coating relative to a bottom half of the coating in amounts, for example, as set forth above. As provided herein, and in the Examples, embodiments of the present disclosure exhibit higher surface roughness relative to conventional high solids coatings, which indicates a significant amount of matting agent oriented close to the surface of the coating. For example, FIG. 1 is a perspective view that is a 3-dimensional display employing interferometer technology that illustrates a coating surface roughness formed by a process of the present disclosure. In contrast, FIG. 2 is a perspective view that is a 3-dimensional display that illustrates a coating surface roughness formed by a conventional process. Both coatings were examined by 3-D modeling equipment commercially available from Veeco Instruments, Inc., Plainview, N.Y. As illustrated in the figures and the Examples, coating compositions comprising 5.7 percent by weight of Syloid 2105 matting agent, and treated with IR and cured by embodiments set forth herein, exhibit significantly different surface roughness properties relative to coating compositions dried and/or cured by conventional processes. For example, the average surface roughness (Ra) exhibited by the coatings of FIG. 1 is 425.14 nm, which is significantly higher than the surface roughness exhibited (295.09 nm in FIG. 2) by conventionally cured coatings without an initial IR treatment. Increased roughness properties, such as root mean square roughness (Rq) and maximum profile height (Rt) are also exhibited by embodiments of the present invention.

At least partly due to the matting agent orientation, and in certain embodiments, the cured coating has been found to exhibit improved haze and gloss properties over those coating compositions that do not employ the methods of the present disclosure. When the substrate is a wood substrate, the natural look of the wood grain may be maintained by embodiments of the present disclosure. For example, and as set forth in the Examples provided herein, embodiments of the cured coating compositions employing the methods set forth herein have been found to exhibit gloss levels for high solids liquid radiation curable compositions of 10 to 60 gloss units, and in some embodiments 30 to 50 gloss units, based on a GLOSS TEST METHOD. As used herein, “GLOSS TEST METHOD” refers to test procedures for determining gloss properties and characteristics of cured coatings, based upon ASTM Test Method D523-89/99, incorporated by reference herein in its entirety. In certain embodiments, the resultant coating can also exhibit reduced haze relative to prior art coatings, improved flexibility and chip resistance, and/or allow the user to deposit thicker coats on the substrate for treatment.

As a result of the improved gloss properties exhibited by the coatings of the present disclosure, in certain embodiments of the present disclosure, the user may reduce the amount of matting agent added to the coating composition, and thereby reduce the material costs associated therewith without impacting gloss properties. For example, in certain embodiments, it has been found that reduction of the matting agent by half provides similar gloss properties compared to convention coating compositions treated and cured by convention techniques. By way of example, it has been found that where certain conventionally cured coating compositions required 5.7 percent by weight of a matting agent to achieve a certain gloss level, certain compositions and methods set forth herein allow for the use of approximately half (2 to 4 percent by weight) of the matting agent to achieve similar gloss level properties. Accordingly, a user employing certain compositions and methods set forth herein may find it beneficial to improve gloss properties of the coated substrate by employing the same amount of matting agent previously employed, reduce the amount of matting agent added to the coating compositions while substantially maintaining existing gloss levels, or some combination thereof.

Coatings including the coating compositions of the present disclosure can provide primer/sealer surfacer, basecoat, topcoat, and monocoat coatings having one or more desirable properties, such as improved gloss, haze, flexibility, and/or chip resistance, and provide manufacturing advantages, including reduced material and/or processing times and costs, over prior art techniques. Although not intending to be bound by any particular theory, it is believed that the mechanism and compositional effects that lead to a concentrated matting agent morphology provide these improved properties.

The invention will be further described by reference to the following example. The following example is merely illustrative of the invention and is not intended to be limiting. Unless otherwise indicated, all parts are by weight.

### EXAMPLE

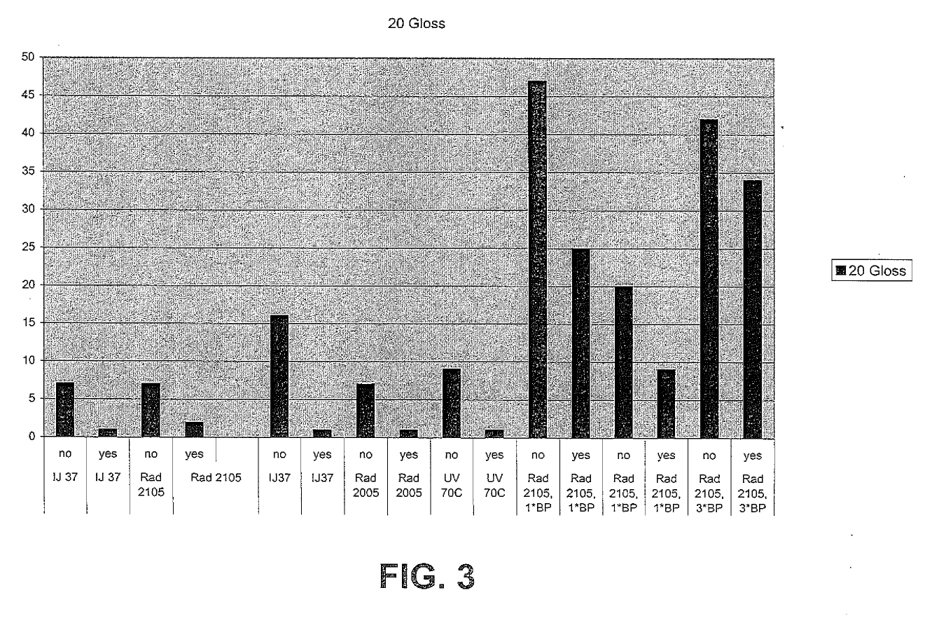

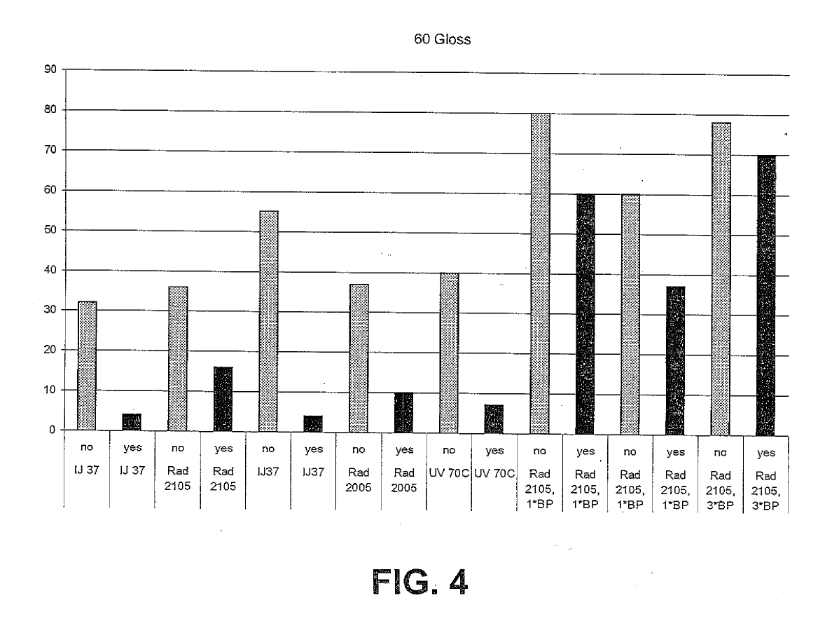

As set forth in Table 1, below, and FIGS. 3 and 4, following extensive optical and rheological testing, it was determined that the “plastic look” of 100% solids UV coatings was related to an increase in the topcoat haziness due to a high load of matting agent. The ability to create a matt effect in traditional water and solvent based coatings using available matting agents is well understood. In contrast, when the coating is a UV curable composition, such as 100% solids, more matting agent is required to compensate for the lack of film shrinkage (i.e. solvent evaporation). It was found that high levels of matting agent in UV curable composition can lead to several problems, such as adverse rheological effects e.g. increasing viscosity with time, inconsistent gloss levels and artificial, “plasticky” appearance. In addition, the 100% solids UV coatings have high 20 degree gloss and low surface roughness. These coatings do not flow and soak in the wood as well as the conventional low solids systems, blocking the pores and making the wood to look unnatural.

It was discovered that by employing an infrared oven right before the UV cure, one or more of these problems were overcome to give a coating with consistent gloss, surface finish, and/or proper cure and resistance properties. As illustrated in Table 1 and FIGS. 3 and 4, coating samples incorporating various matting agents and exposed to IR radiation for 5 to 10 seconds were found to have lower 60 and 20 degree gloss, higher surface roughness and improved general appearance. It is believed that the IR treatment helps to decrease coating viscosity, hence enhancing the flow and soak into the wood pores. Concomitantly, it was found that IR application increases the matting efficiency by allowing the matting agent to easily float to the surface. In addition to improving the natural appearance of finished wood, it was found that the IR treatment provides other advantages, such as the use of less matting agent, and the ability to use thicker coatings.

100% solids UV curable sealer (R1742Z49, commercially available from PPG Industries) was sprayed onto the stained wood board, UV cured and sanded. A 100% solids UV curable topcoat (R1707Z83, commercially available from PPG industries) containing different matting agents and matting agent concentrations, as provided in Table 1, were also employed. Different topcoat formulations were sprayed onto the sanded sealer. Some of the samples were cured conventionally with UV radiation while other samples were passed first through an IR oven, and then cured with UV radiation. The 20 and 60 degree gloss values as well as the transmission haze were measured. As seen from Table 1 and FIGS. 3 and 4, the gloss values were consistently lower for the IR treated samples, identified as “yes” or “IR yes.” Most of the formulations also show decreased haze. As illustrated, samples having 1*(0.66% by weight) and 3*(2% by weight) concentration of benzophenone (BP) were tested to determine what effect various amounts of initiator would have on the haze and gloss properties. These results are also provided in Table 1 and FIGS. 3 and 4.

TABLE 1

| | | Concentration | | Trans | 20 | 60 |
|---|---|---|---|---|---|---|
| | Matting Agent | % | IR | Haze | Gloss | Gloss |
| Sample ID | | | | | | |
| 1 | IJ 37 | 5.7 | no | 10.1 | 7 | 32 |
| 2 | IJ 37 | 5.7 | yes | 8.7 | 1 | 4 |
| 3 | Rad 2005 | 5.7 | no | 12.9 | 2 | 16 |
| 4 | Rad 2105 | 5.7 | no | 8.2 | 7 | 36 |
| 5 | Rad 2105 | 5.7 | yes | 8.2 | 2 | 16 |
| 6 | UV 70C | 5.7 | no | 11.3 | 4 | 22 |
| 7 | HP220 | 5.7 | no | 8.1 | 7 | 35 |
| 8 | IJ37 | 4 | no | 2.4 | 16 | 55 |
| 9 | IJ37 | 4 | yes | 3.4 | 1 | 4 |
| 10 | Rad 2005 | 4 | no | 4.8 | 7 | 37 |
| 11 | Rad 2005 | 4 | yes | 6 | 1 | 10 |
| 12 | UV 70C | 4 | no | 3.7 | 9 | 40 |
| 13 | UV 70C | 4 | yes | 4.1 | 1 | 7 |
| Surface | | | | | | |
| Cure | | | | | | |
| Studies | | | | | | |
| 14 | Rad 2105, 1*BP | 2 | yes | 0.7 | 25 | 60 |
| 15 | Rad 2105, 1*BP | 4 | no | 2.6 | 20 | 60 |
| 16 | Rad 2105, 1*BP | 4 | yes | 1.9 | 9 | 37 |
| 17 | Rad 2105, 3*BP | 2 | no | 0.8 | 42 | 78 |
| 18 | Rad 2105, 3*BP | 2 | yes | 1.7 | 34 | 70 |
| 19 | Rad 2105, 3*BP | 4 | no | 3 | 10 | 38 |
| 20 | Rad 2105, 3*BP | 4 | yes | 2.6 | 13 | 50 |

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

1. A method of treating a liquid radiation curable coating composition on a substrate, comprising:
applying an IR treatment to the liquid radiation curable coating composition; and
applying a radiation curable treatment to the liquid radiation curable coating composition.

2. The method of claim 1, wherein the coating composition comprises a solids content of at least 50% solids.

3. The method of claim 2, wherein the coating composition is substantially 100% solids.

4. The method of claim 1, wherein the IR treatment is applied to the coating composition prior to the radiation curable treatment to orient the matting agent toward a surface of the coating composition.

5. The method of claim 1, wherein the IR treatment is applied to the coating composition prior to the radiation curable treatment for 1 to 10 seconds.

6. The method of claim 1, wherein the IR treatment is applied to the coating composition at an intensity level in the range of 5000 to 25000 nanometers at a peak temperature range.

7. The method of claim 1, wherein the radiation curable treatment is a UV treatment that is applied to the coating composition at a total energy level in the range of 250 to 1500 nanometers.

8. The method of claim 1, wherein the liquid radiation curable coating composition is adjacent to the substrate.

9. The method of claim 1, wherein the liquid radiation curable coating composition is adjacent to at least a portion of at least one second coating composition.

10. (canceled)

11. The method of claim 1, wherein the radiation curable treatment substantially cures the liquid radiation curable coating composition.

12. The method of claim 1, wherein the radiation curable treatment substantially cures the liquid radiation curable coating composition to exhibit a gloss level of 10 to 60 gloss units based on a GLOSS TEST METHOD.

13. A coating composition, comprising:
a film-forming component;
a radiation-curable group; and
a matting agent, wherein, when the composition is deposited and treated to form a cured coating, the cured coating is characterized as having a higher concentration of the matting agent in a top half of the coating relative to a bottom half of the coating.

14. The coating composition of claim 13, wherein at least 70% by weight of the matting agent present in the radiation-curable coating composition is present in the top half of the cured coating.

15. The coating composition of claim 13, wherein the coating composition is a UV curable composition and comprises a solids content of at least 50% solids.

16. The coating composition of claim 15, wherein the coating composition is a UV curable composition and comprises substantially 100% solids.

17. The coating composition of claim 13, wherein the coating composition, when cured, has a gloss level of 10 to 60 gloss units based on a GLOSS TEST METHOD.

18. The coating composition of claim 17, wherein the matting agent is present in an amount of 0.1 to 6 weight percent based on the weight of the coating composition.

19. A liquid radiation curable coating composition, comprising:
a matting agent present in an amount of 1 to 6 weight percent based on the weight of the coating composition, wherein, when the composition is applied and treated to form a cured coating, the cured coating is characterized as having a maximum gloss level of 10 to 60 gloss units, based on a GLOSS TEST METHOD.

20. The coating composition of claim 19, wherein the coating composition is characterized as having a maximum gloss level of 30 to 50 gloss units, based on the GLOSS TEST METHOD.

21. The coating composition of claim 19, wherein when the composition is deposited and treated to form a cured coating, the cured coating is characterized as having a concentrated matting agent morphology in the top half of the coating.

22. The coating composition of claim 19, wherein at least 70% by weight of the matting agent present in the coating composition is present in the top half of the cured coating.

23. The coating composition of claim 19, wherein the coating composition comprises a solids content of at least 50% solids.

24. The coating composition of claim 23, wherein the coating composition is substantially 100% solids.

25. A liquid radiation curable coating composition, comprising:
a matting agent present in an amount of 1 to 6 weight percent based on the weight of the coating composition, wherein, when the composition is deposited and treated to form a cured coating, the cured coating is characterized as having a maximum gloss level of 10 to 60 gloss units, based on a GLOSS TEST METHOD.

26. A method of altering an orientation of a matting agent distributed substantially uniformly in a liquid radiation curable coating composition positioned on a substrate, comprising:
(a) applying an IR treatment to the liquid radiation curable coating composition comprising the matting agent; and
(b) applying a radiation curable treatment to the liquid radiation curable coating composition following the IR treatment, wherein, when cured, a higher concentration of the matting agent by weight percent is oriented near a top half of the coating relative to a bottom half of the coating.
